(19) United States
(12) Patent Application Publication
(10) Pub. No.: US 2012/0213589 A1
(43) Pub. Date: Aug. 23, 2012

(54) SYSTEM, APPARATUS AND METHOD FOR SOIL REMEDIATION

(76) Inventor: Lorne Bates, Red Deer (CA)

(21) Appl. No.: 13/358,514

(22) Filed: Jan. 25, 2012

Related U.S. Application Data
(60) Provisional application No. 61/436,586, filed on Jan. 26, 2011.

(30) Foreign Application Priority Data
Jan. 25, 2011 (CA) 2729134

(51) Int. Cl. B09C 1/00

(52) U.S. Cl. 405/128.7

(57) ABSTRACT

In one aspect, a soil remediation device is provided. The soil remediation device can have a collector for receiving soil to be treated. From the collector, the soil can be moved into a comminuting section where the soil can be broken up, typically with blades and flail hammers. The comminuting of the soil can cause the soil to be heated up as a result of friction, causing some contaminants in the soil to be volatized and released therefrom. Once the soil has been comminuted by the soil remediation device, it can be discharged. A fume hood can cover the outlet of the comminuting section so that soil that has been discharged from the comminuting section of the soil remediation device is substantially covered by the fume hood. The fume hood can act to contain volatized contaminants exiting the comminuted soil and rising upwards in the fume hood.

### CROSS REFERENCE TO RELATED APPLICATION

This application is a regular application of U.S. Provisional Patent Application Ser. No. 61/436,586 filed Jan. 26, 2011 and entitled, “SYSTEM, APPARATUS AND METHOD FOR SOIL REMEDIATION”, the entirety of which is incorporated herein by reference.

### FIELD OF THE INVENTION

The present invention relates to a device for remediating soil and more particularly to a device that comminutes the soil and extracts volatized contaminants from the comminuted soil.

### BACKGROUND OF THE INVENTION

Hydrocarbon contaminated soil has become a problem in many areas. Soil can become contaminated with hydrocarbon as a result of leaks from storage tanks, pipeline ruptures, etc. Not only can hydrocarbon contaminate soil, but it can also spread to ground water.

There are a number of ways that soil can be treated when it is contaminated with hydrocarbon including bio-remediation, soil washing, soil flushing, thermal treatment etc. However, there is often a problem with removing contaminants from one type of media to another (i.e. removing hydrocarbon from soil and releasing it into the air). In many jurisdictions, such as Alberta, Canada, contaminants such as hydrocarbons, etc. in one media cannot be transferred to another media. For example, if soil containing hydrocarbons is to be cleaned, the hydrocarbons cannot be converted into volatiles and released into the air.

### SUMMARY OF THE INVENTION

In one aspect, a soil remediation device is provided. The soil remediation device can have a collector for receiving soil to be treated. From the collector, the soil can be moved into a comminuting section where the soil can be broken up, typically with blades and flail hammers. The comminuting of the soil can cause the soil to be heated up as a result of friction, causing some contaminants in the soil to be volatized. These volatized contaminants can be released from the soil.

Once the soil has been comminuted by the soil remediation device, it can be discharged from the comminuting section. A fume hood can cover the outlet of the comminuting section so that soil that has been discharged from the comminuting section of the soil remediation device is substantially covered by the fume hood. The fume hood can act to contain volatized contaminants exiting the comminuted soil and rising upwards in the fume hood.

In one aspect, a vapor extraction unit can be provided to remove vapor from the fume hood, including the volatized contaminants contained by the fume hood.

A discharge conveyor can be provided at the outlet of the comminuting section so that soil discharged out of the comminuting section is deposited on the discharge conveyor, which in turn, will carry the soil out from under the fume hood to be deposited on the ground surface or in a pile of soil.

### BRIEF DESCRIPTION OF THE DRAWINGS

A preferred embodiment of the present invention is described below with reference to the accompanying drawings, in which:

FIG. 1 is a schematic side view of a soil remediation device in one aspect of the invention;

FIG. 2 is a schematic top view of a soil remediation device in one aspect of the invention;

FIG. 3 is a side schematic view of the comminuting section of a soil remediation device;

FIG. 4 is a top schematic view of the comminuting section of a soil remediation device;

FIG. 5 is a side view of a fume hood used in the soil remediation device shown in FIG. 1; and

FIG. 6 is a end view of a fume hood shown in FIG. 5.

### DETAILED DESCRIPTION OF THE PREFERRED EMBODIMENTS

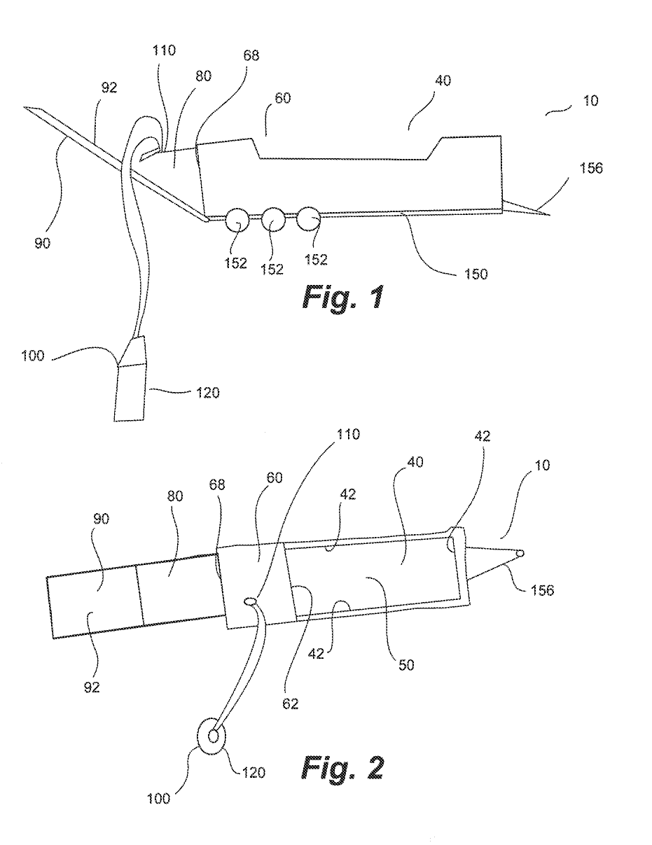

FIGS. 1 and 2 illustrate a soil remediation apparatus 10 in one aspect. The soil remediation apparatus 10 has a collector 40 for receiving soil and a comminuting section 60 on one end of the collector 40 for breaking up the soil. Contaminated soil is fed into the soil remediation apparatus 10 in the collector 40 and passed into the comminuting section 60 where the soil is comminuted and heated, releasing volatized hydrocarbon and other contaminants from the soil. A fume hood 80 can be provided at an outlet 68 of the comminuting section 60 to try and contain any of the volatized contaminants released from the soil.

A fume hood 80 can be provided after an outlet 68 of the comminuting section 60 so that comminuted and heated soil is discharged onto the discharge conveyor 90 under the fume hood 80. The fume hood 90 can collect and contain volatized hydrocarbon exiting the remediate soil, where the volatized hydrocarbon can be removed from the fume hood 80 by a vapor extraction unit 100.

The soil remediation apparatus 10 can be provided on a trailer 150 with wheels 152 so that the soil remediation apparatus 10 can be transported from location to location. A towing apparatus 156 can be provided on one end of the soil remediation apparatus 10 so that the soil remediation apparatus 10 can be coupled to a tow vehicle (not shown).

An engine, such as a diesel engine, can be provided to drive the various conveyors, etc. of the soil remediation apparatus 10.

The collector 40 can have walls 42 and an open top so that contaminated soil can be fed into the collector 40. A conveyor 50 can be provided in the bottom of the collector 40 for moving soil towards the comminuting section 60 of the soil remediation apparatus 10. Soil deposited in the collector 40 can be directed by the walls 42 onto the conveyor 50 where the conveyor 50 can move the soil towards the end of the collector 40, where the comminuting section 60 is provided. In this manner, the conveyor 50 can feed soil to the comminuting section 60.

The comminuting section 60 can be used to break up the soil. In addition to breaking up the soil, the comminuting section 60 can heat the soil by means of friction to cause contaminants in the soil to increase in heat and escape from the soil due to volatilization. Soil can pass through an inlet 62 into the comminuting section 60 where it is comminuted and heated by friction, before being discharged out of the comminuting section 60 through a discharge outlet 68.

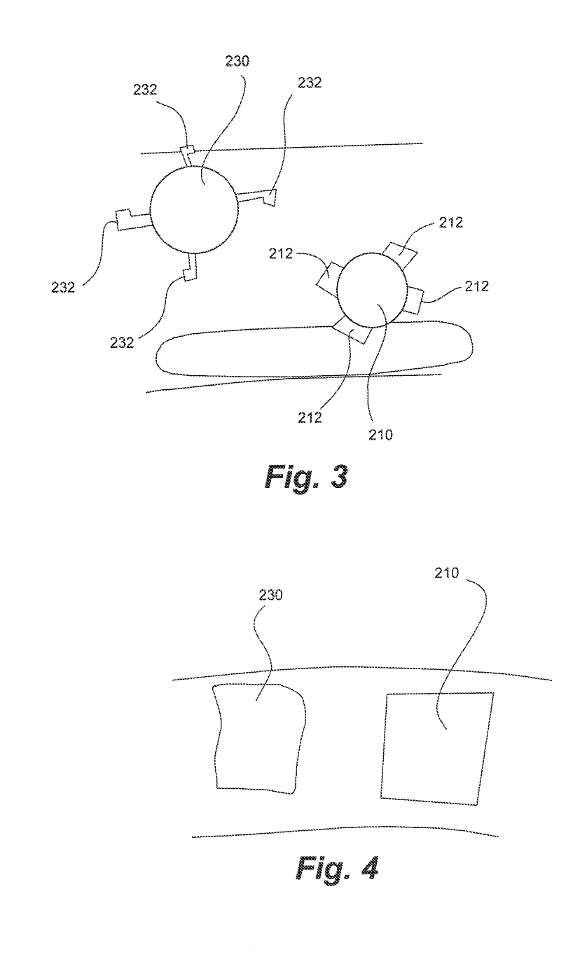

Referring to FIGS. 3 and 4, in one aspect, the comminuting section 10 can have a first shredding roller 210 and a flail drum 230 to comminute the soil passing through the comminuting section 60. The shredding roller 210 can comprise a plurality of knives 212 extending radially from the shredding roller 210. Each of the knives 212 on the shredding roller 210 can be laterally spaced apart from adjacent knives 212. The shredding roller 210 can be positioned overtop of the conveyor 50 so that soil being transported by the conveyor 50 is passed under the shredding roller 210 so that the knives 212 can pass through the soil, comminuting the soil as it passes under the shredding roller 210. In addition to the comminuting the soil, friction caused by the knives 212 passing through the soil can cause the soil to heat up causing some of the contaminants in the soil to be volatized and released from the soil.

Behind the first shredding roller 210, a flail drum 230 can be provided so that soil 5 that has passed by the shredding roller 210 can be passed to the flail drum 230. The flail drum 230 can contain a plurality of flail hammers 232 that are rotatably attached at one end to the flail drum 230. The flail drum 230 can be provided after the shredding roller 210 in the comminuting section 60 so that soil that has already been comminuted and heated up by the shredding roller 210 is passed to the flail drum 230 to be further comminuted and heated up by the impact of the flail hammers 232 on the soil.

Once the soil has passed through the comminuting section 60, it can be discharged out an outlet 68 onto a discharge conveyor 90. A fume hood 80 can be provided around the outlet 68 so that any volatized contaminants that have been released from the soil as a result of being comminuted and heated in the comminuting section 60 can be captured by the fume hood 80.

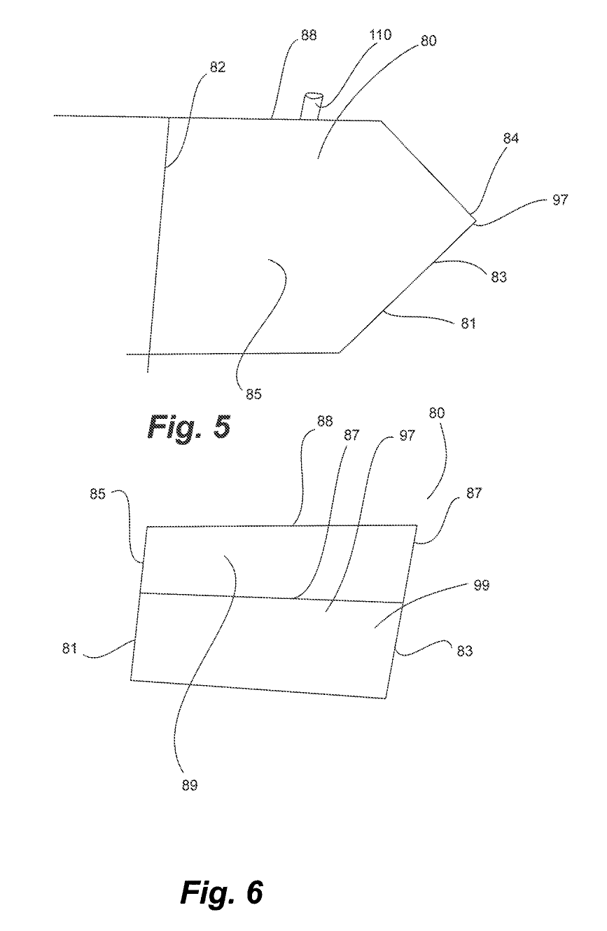

Referring to FIGS. 5 and 6, the fume hood 80 can have a first end 82 connected to the outlet 68 of the comminuting section 60 and a second end 84 positioned over the discharge conveyor 90. The fume hood 80 can contain a pair of side walls 85, 87 extending from the sides of the outlet 68. A top panel 88 of the fume hood 80 can extend horizontally from the top of the outlet 68. At the second end 84 of the fume hood 80, an end panel 89 can be joined to the top panel 88 with the end panel 89 angled downwards to direct volatized contaminants rising upwards in the fume hood 80 towards the top panel 88.

In one aspect, the side panels 85, 87 can have angled bottom edges 81, 83 with the angle of the bottom edges 81, 83 substantially matching the angle of the discharge conveyor 90 when it is in its operating position.

In one aspect, the end panel 89 can be positioned so that a bottom edge 81, 83 of the end panel 89 is positioned proximate to a top surface 92 of the discharge conveyor 90 when the discharge conveyor 90 is in its operating position. The bottom edge 81, 83 of the end panel 89 can be positioned a slight distance away from the top surface 92 of the discharge conveyor 90 when the discharge conveyor 90 is in its operation position so that a gap 99 formed between the bottom edge 97 of the end panel 89 of the fume hood 80 and the top surface 92 of the discharge conveyor 90 through which soil being discharged from the comminuting section 60 of the soil remediation device 10 can pass under the bottom edge 97 of the end panel 89.

Referring again to FIGS. 1 and 2, a vapor extraction outlet 110 can be provided in the fume hood 80 at or near the top of the fume hood 80 to extract volatized contaminants from the fume hood 80. In one aspect, the vapor extraction outlet 110 can be provided passing through the top panel 88 of the fume hood 80. The vapor extraction outlet 110 can be connected to a vapor extraction unit 100 that can create a vacuum, removing volatized contaminants from the fume hood 80. The volatized contaminants removed from the fume hood 80 by the vapor extraction unit 100 can be contained and stored for later treatment. Such as by collecting the volatized contaminants removed from the fume hood 80 by the vapor extraction unit 100 in a tank 120.

The discharge conveyor 90 can be angled upwards during operation so that it carries soil discharged from the comminuting section 60 of the soil remediation device 10 out of the fume hood 80 and upwards to be discharged from the discharge conveyor 90 to form a pile of soil.

In Operation

In operation, soil to be remediated can be dumped into the collector 40 of the soil remediation apparatus 10. The soil in the collector 40 can be directed onto the conveyor 50 by the walls 42 of the collector 40 and the conveyor 50 can carry the soil towards the comminuting section 60 of the soil remediation apparatus 10. At the comminuting section 60 of the soil remediation apparatus 10, the conveyor 50 can feed the soil into the inlet 62 of the comminuting section 60.

Inside the comminuting section 60, the soil can be comminuted. The friction 15 caused by comminuting the soil in the communication section 60 can cause the soil being comminuted to heat up. By heating up the soil, contaminants in the soil can be volatized and these volatized contaminants can then exit the soil as the soil is comminuted and mixed up in the communication section 60 of the soil remediation apparatus 10. Once the soil and the volatized contaminants have passed through the comminuting section 60, they can be discharged out the outlet 68 of the comminuting section 60 and onto the discharge conveyor 90.

It is undesirable to allow the volatized contaminants that have been released from the soil to simply be discharged into the atmosphere. Not only does allowing the volatized contaminants to enter the atmosphere cause pollution and potentially a safety hazard because of their potential flammability, but additionally, in certain jurisdictions it unlawful to allow volatized contaminants that have been removed from soil to be discharged into the atmosphere. Rather than have the volatized contaminants simply escape into the atmosphere, the fume hood 80 can try and contain the volatized contaminants being released from the soil. The volatized contaminants can rise inside the fume hood 80 while the soil is carried out of the fume hood 80 by the discharge conveyor 90. These volatized contaminants can rise inside the fume hood 80 towards the vapor extraction outlet 110 where the vapor extraction unit 100 can remove the volatized contaminants from the fume hood 80, carrying these volatized contaminants off to be stored until they can be properly dealt with.

The soil that is carried out of the fume hood 80 by the discharge conveyor 90 can be carried along the discharge conveyor 90 to be discharged onto a ground surface to form a pile of soil. Advantageously, the pile of soil can have an elevated temperature causing any non-volatile contaminants to biodegrade at a more rapid rate than untreated soil.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

The embodiments of the invention in which an exclusive property or privilege is being claimed are defined as follows:

1. A soil remediation apparatus comprising:
a collector for receiving soil;
a comminuting section on one end of the collector for breaking up the soil and having means for comminuting said soil; and
heating means for heating the comminuted soil.

2. The soil remediation apparatus of claim 1 further comprising a fume hood for containing any volatized contaminants that may be released from the comminuted soil.

3. The soil remediation apparatus of claim 2 further comprising a discharge conveyor associated with an outlet of the comminuting section; and
wherein the fume hood is provided after said outlet of the comminuting section.

4. The soil remediation apparatus of claim 2 further comprising a vapor extraction unit associated with the fume hood for removing any volatized hydrocarbons from the fume hood.

5. The soil remediation apparatus of claim 1 wherein the collector comprises walls and an open top, the soil remediation apparatus further comprising a conveyor in the collector to feed soil to the comminuting section.

6. The soil remediation apparatus of claim 1 wherein the heating means is the comminuting section heating the soil by friction.

7. The soil remediation apparatus of claim 5 wherein the means for comminuting said soil comprises a shredding roller.

8. The soil remediation apparatus of claim 7 wherein the shredding roller further comprises a plurality of knives extending radially from the shredding roller.

9. The soil remediation apparatus of claim 8 wherein the shredding roller is positioned overtop of the conveyor in the collector so that soil being transported by said conveyor in the collector is passed under the shredding roller so that the plurality knives can pass through the soil, comminuting the soil as it passes under the shredding roller.

10. The soil remediation apparatus of claim 9 wherein the heating means is the plurality of knives passing through the soil and heating said soil by friction.

11. The soil remediation apparatus of claim 5 wherein the means for comminuting said soil comprises a flail drum.

12. The soil remediation apparatus of claim 11 wherein the flail drum further comprises a plurality of flail hammers that are rotatably attached at one end to said flail drum.

13. The soil remediation apparatus of claim 12 wherein the flail drum is positioned overtop of the conveyor in the collector so that soil being transported by said conveyor in the collector is passed under the flail drum so that the plurality flail hammers can impact the soil.

14. The soil remediation apparatus of claim 13 wherein the heating means is the plurality of flail hammers impacting the soil and heating said soil by friction.

15. A method of remediation soil comprising:
comminuting the soil;
causing the comminuted soil to heat up and volatize any contaminants that may be within said comminuted soil; and
containing some of said volatized contaminants;

16. The method of claim 15 further comprising placing the comminuted soil in a pile and allowing any non-volatile contaminants to biodegrade.

17. A soil remediation apparatus comprising:
means for comminuting the soil; and
heating means for heating the comminuted soil;
wherein the heating means is the same as the means for comminuting the soil.

18. The soil remediation apparatus of claim 17 wherein the means for comminuting said soil comprises a shredding roller having a plurality of knives extending radially from the shredding roller and wherein the heating means is the plurality of knives passing through the soil and heating said soil by friction.

19. The soil remediation apparatus of claim 17 wherein the means for comminuting said soil comprises a flail drum having a plurality of flail hammers rotatably attached to said flail drum and wherein the heating means is the plurality of flail hammers impacting the soil and heating said soil by friction.
